(19) United States
(12) Patent Application Publication
(10) Pub. No.: US 2013/0251940 A1
(43) Pub. Date: Sep. 26, 2013

(54) METHOD OF CUTTING AN INGOT FOR SOLAR CELL FABRICATION

(71) Applicants: Sheng Sun, Foster City, CA (US); Fernando Boyon, Albay (PH); Roy Joseph Legaspi, Laguna (PH); Matthew Dawson, Menlo Park, CA (US); Chuck Stone, Cedar Park, TX (US)

(72) Inventors: Sheng Sun, Foster City, CA (US); Fernando Boyon, Albay (PH); Roy Joseph Legaspi, Laguna (PH); Matthew Dawson, Menlo Park, CA (US); Chuck Stone, Cedar Park, TX (US)

(21) Appl. No.: 13/429,141

(22) Filed: Mar. 23, 2012

(51) Int. Cl. B32B 3/10; B28D 1/08; C01B 33/02

(52) U.S. Cl. 428/131; 125/21; 423/348

(57) ABSTRACT

Methods of cutting ingots for solar cell fabrication, as well ingots and grippers there for, are described. In an example, a method of cutting an ingot includes gripping a portion of the ingot directly with a gripper of a cutting apparatus. The ingot is partially cut to form a plurality of wafer portions projecting from an uncut portion of the ingot. The ingot is further cut to separate the plurality of wafer portions from the uncut portion, to provide a plurality of discrete wafers.

### TECHNICAL FIELD

Embodiments of the present invention are in the field of renewable energy and, in particular, methods of cutting ingots for solar cell fabrication.

### BACKGROUND

Ingot slicing, such as silicon ingot slicing, into wafers typically involves using a rectangular beam piece epoxy glued to the ingot. A wire saw work piece is used to hold the beam during the slicing process. Upon completion of slicing, e.g., with a multi-wire web having completely sliced through the ingot and into the beam, a clean separation of the formed wafers must be performed. The separation from the beam must be made with care in order to preserve the final edge of the formed wafers. Following wireweb slicing, the sliced ingot is often loaded into a debond and precleaner tool and undergoes pre-cleaning followed by the epoxy degluing process. Beams used are typically composed of glass for the slurry slicing, or graphite or resin materials for diamond-wire slicing.

### BRIEF DESCRIPTION OF THE DRAWINGS

FIG. 1 is a flowchart representing operations in a method of cutting an ingot for solar cell fabrication, in accordance with an embodiment of the present invention.

FIG. 2A illustrates an operation in a method of cutting an ingot for solar cell fabrication, corresponding to operation 102 of the flowchart of FIG. 1, in accordance with an embodiment of the present invention.

FIG. 2B illustrates an operation in a method of cutting an ingot for solar cell fabrication, corresponding to operation 104 of the flowchart of FIG. 1, in accordance with an embodiment of the present invention.

FIG. 2C illustrates an operation in a method of cutting an ingot for solar cell fabrication, corresponding to operation 106 of the flowchart of FIG. 1, in accordance with an embodiment of the present invention.

FIG. 3 illustrates an end view of a mono-crystalline silicon ingot, in accordance with an embodiment of the present invention.

FIG. 4A illustrates an end view of a multi-crystalline silicon ingot, in accordance with an embodiment of the present invention.

FIG. 4B illustrates an end view of an ingot, in accordance with an embodiment of the present invention.

FIG. 5 illustrates a block diagram of an example of a computer system configured for performing a method of cutting an ingot for solar cell fabrication, in accordance with an embodiment of the present invention.

### DETAILED DESCRIPTION

Methods of cutting ingots for solar cell fabrication, as well ingots and grippers there for, are described herein. In the following description, numerous specific details are set forth, such as specific ingot keyhole geometries, in order to provide a thorough understanding of embodiments of the present invention. It will be apparent to one skilled in the art that embodiments of the present invention may be practiced without these specific details. In other instances, well-known fabrication techniques, such as approaches to forming solar cells from individual wafers cut from ingots, are not described in detail in order to not unnecessarily obscure embodiments of the present invention. Furthermore, it is to be understood that the various embodiments shown in the figures are illustrative representations and are not necessarily drawn to scale.

Disclosed herein are methods of cutting ingots. In one embodiment, a method of cutting an ingot includes gripping a portion of the ingot directly with a gripper of a cutting apparatus. The ingot is partially cut to form a plurality of wafer portions projecting from an uncut portion of the ingot. The ingot is further cut to separate the plurality of wafer portions from the uncut portion, to provide a plurality of discrete wafers.

Also disclosed herein are ingots for fabricating of solar cells. In one embodiment, an ingot for fabricating a plurality of solar cells has four major surfaces oriented along a central axis of the ingot. The first major surface is different from two or more of the remaining three major surfaces. A pair of ends is approximately orthogonal to the four major surfaces.

Also disclosed herein are grippers for use during ingot cutting. In one embodiment, a gripper for holding an ingot during a cutting process includes a first end having a first plurality of keys. The first set of keys is for gripping a first set of keyholes of the ingot directly. The gripper also includes a second end having a second plurality of keys. The second set of keys is for gripping a second set of keyholes of the ingot directly. The gripper also includes a central portion between and aligning the first and second ends. The central portion is adaptable to integrate with a cutting apparatus.

Single crystal ingots (typically referred to as called boules) of materials are grown (e.g., by crystal growth) using methods such as the Czochralski process or Bridgeman technique. The boules may be used to produce silicon wafers for use in, e.g., solar or other industries such as the electronic industry. Multi-crystal ingots may also be used to form wafers for various applications. Ingots are typically manufactured by the freezing of a molten liquid (often referred to as the melt) in a mold. The manufacture of ingots in a mold is designed to completely solidify and form an appropriate grain structure required for later processing, since the structure formed by the freezing melt controls the physical properties of the material. Furthermore, the shape and size of the mold is designed to allow for ease of ingot handling and downstream processing. Typically, the mold is designed to minimize melt wastage and aid ejection of the ingot, as losing either melt or ingot increases manufacturing costs of finished products. The physical structure of a crystalline material is largely determined by the method of cooling and precipitation of the molten metal.

Different approaches have been used to slice ingots into wafers, e.g., into single crystalline silicon wafers. A common approach involves beam handling of the ingot, as described above. Limitations of the beam handing and related approaches may include a requirement of extra processing operations such as beam bonding and debonding, higher cost, and additional capital expenditure. For example, beam bonding is often a material-sensitive operation, preferably performed in a temperature and humidity controlled environment. Beam debond and wafer preclean are additional process operations which can be labor intensive or involve additional capital equipment. The cost of the debond/pre-clean operations can add $0.01-$0.02/wafer, while beam/epoxy costs can add $0.005-$0.01/wafer. Extra capital expenditure may need to be budgeted for bonding tools and debond/precleaner tools, along with added extra labor. Furthermore, a more stringently environmentally controlled room may be required for performing a beam to ingot bonding process, as well as for handling and waste treatment associated with the debonding/pre-clean operations tank discharge. Yield loss attributable to the beam to ingot bonding and debonding operations may also be expected since additional processing operations often introduce measurable yield loss. In particular, the beam gluing may be a tedious operation with associated error risk even with the use of responsible and skilled labor, or expensive capital equipment.

Additional considerations or drawbacks of the beam approach to slicing ingots include the epoxy holding strength being a function of drying time, temperature, and humidity, plus the staging time. The wafer debonding process is also sensitive to the epoxy holding strength, the debond chemistry, temperature, and time. The amount of epoxy used may also be critical, since an excess or deficiency may be associated with unwanted formation of edge and corner chips. The overall yield loss of such bonding/sawing/debonding may amount to 3-5%, and so the impact on usable silicon obtained is non trivial. The beam to ingot bonding process may take a few hours to half a day, depending on the epoxy and the beam materials used, as well as epoxy drying conditions. Therefore, ingots often require allocation in advance, typically by at least one shift. These precious ingots can add factory queue times and impact throughput logistics. Additional time consideration come with the debond/preclean operations.

In accordance with an embodiment of the present invention, beamless ingot slicing approaches are described herein. Beamless ingot slicing, in one embodiment, effectively involves the use of an ingot itself (e.g., a silicon ingot) as a beam or structural support. In this way, self-clamping of an ingot can be used to essentially eliminate the need for a debond operation, as described in greater detail below. The above drawbacks and issues typically associated with beam slicing of an ingot may be mitigated or eliminated by one or more of the embodiments of beamless ingot slicing described herein. As such, the costs typically associated with non-sawing peripheral operations may be kept to a minimum, and non-sawing operation yield loss may be removed as a yield impact factor. In particular embodiments, methods described herein may be cost competitive for both mono-crystalline silicon (e.g., rounded) ingots and casted multi-crystalline (e.g., squared) ingots.

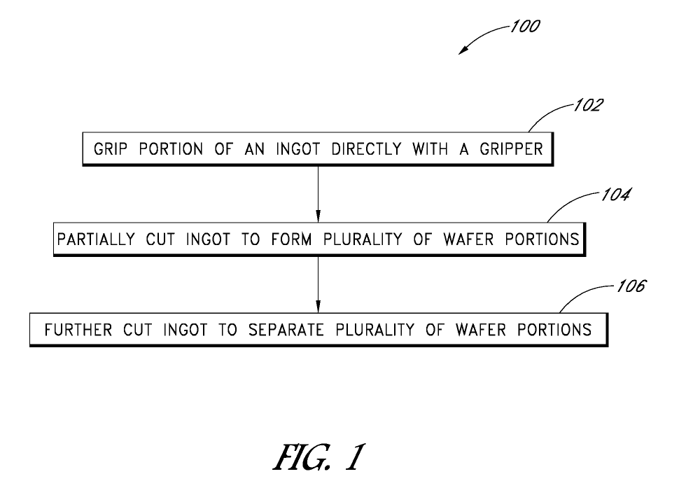

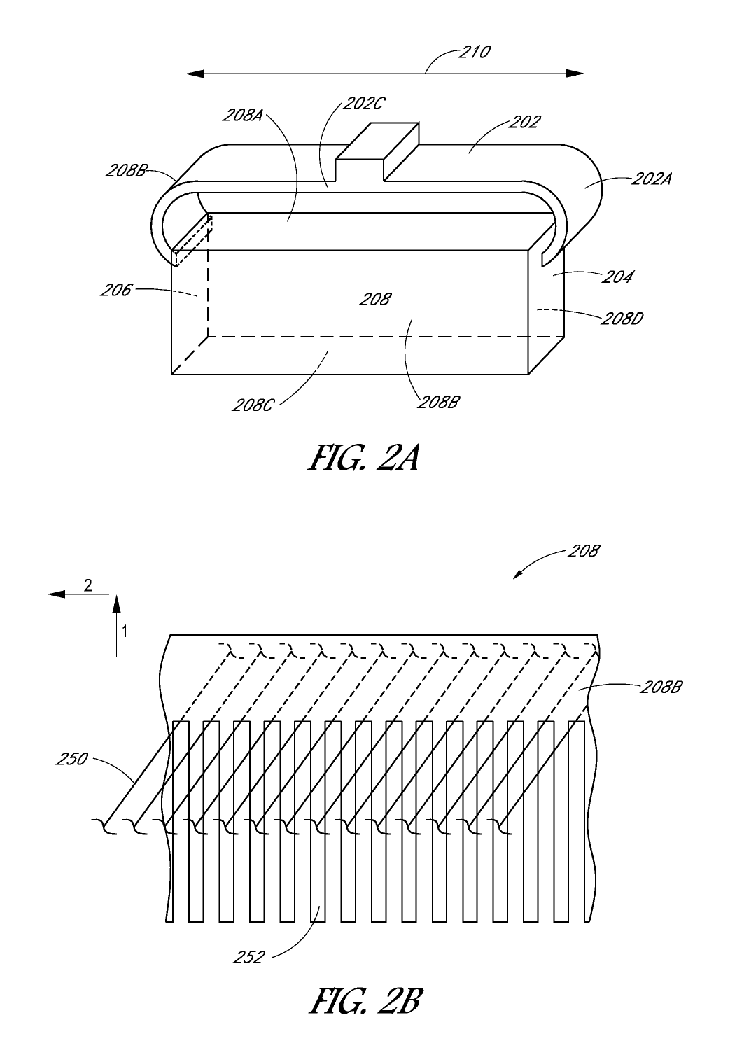

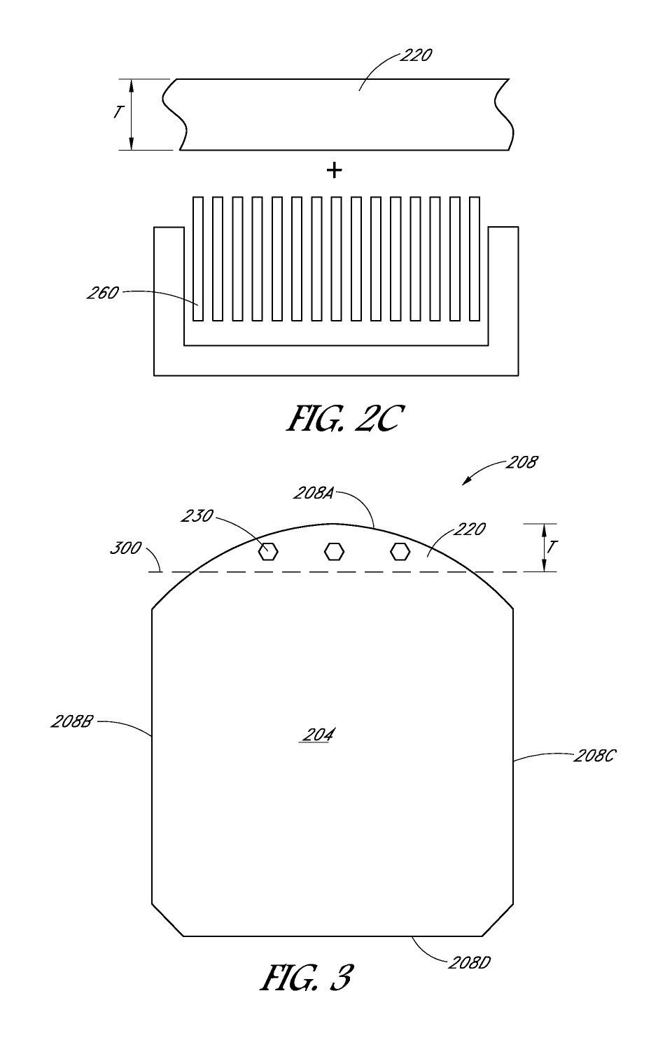

Thus, in an aspect, methods of cutting ingots are described herein. For example, FIG. 1 is a flowchart 100 representing operations in a method of cutting an ingot for solar cell fabrication, in accordance with an embodiment of the present invention. FIGS. 2A-2C illustrate various operations in a method of cutting an ingot for solar cell fabrication, corresponding to the operations of flowchart 100, in accordance with an embodiment of the present invention.

Referring to operation 102 of flowchart 100 a method of cutting an ingot includes gripping a portion of the ingot directly with a gripper of a cutting apparatus. For example, referring to corresponding FIG. 2A, a gripper 202 is used to grip two surfaces 204/206 of an ingot 208 directly.

In an embodiment, the ingot 208 is gripped by the gripper 202 at both ends of the ingot (e.g., where surfaces 204/206 are the ends of the ingot 208) along a first 208A of four major surfaces (208A, 208B, 208C, and 208D) oriented along a central axis 210 of the ingot 208, as depicted in FIG. 2A. In one such embodiment, the first major surface 208A is different from two or more of the remaining three major surfaces (208B, 208C, and 208D).

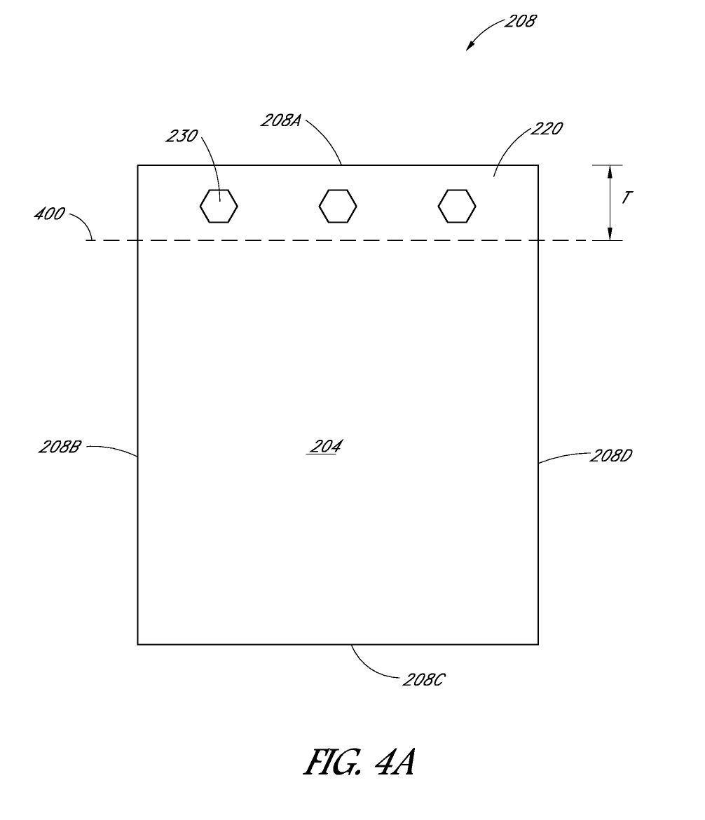

In a first example, the first major surface 208A is different from all three of the remaining three major surfaces (208B, 208C, and 208D). Particularly, FIG. 3 illustrates an end view of a mono-crystalline silicon ingot, in accordance with an embodiment of the present invention. Referring to FIG. 3, an end 204 of a mono-crystalline silicon ingot 208 is formed from the terminating ends of a first major surface 208A and three remaining major surfaces 208B, 208C and 208D. The remaining three major surfaces 208B, 208C and 208D each have a substantially flat portion having a surface area (when considered as an ingot projecting into the page). In one embodiment, the first major surface 208A has a no flat portion such that the rounded shape of the ingot is preserved on that surface, as depicted in FIG. 3. In another embodiment, the first major surface 208A is partially slabbed to have a substantially flat portion having a surface area less than each of the surfaces areas of the substantially flat portions of the remaining three major surfaces. By contrast, a mono-crystalline ingot used for beam-based slicing would first be slabbed to have all four surfaces substantially the same, e.g., where surface 208A would otherwise be the same as surfaces 208B, 208C and 208D, as depicted by the dashed line 300. However, in accordance with an embodiment of the present invention, surface 208A is either not slabbed or only partially slabbed to retain a portion 220 as part of the ingot. In one embodiment, portion 220 is used as a sacrificial portion of the ingot 208 for beamless slicing of the ingot 208.

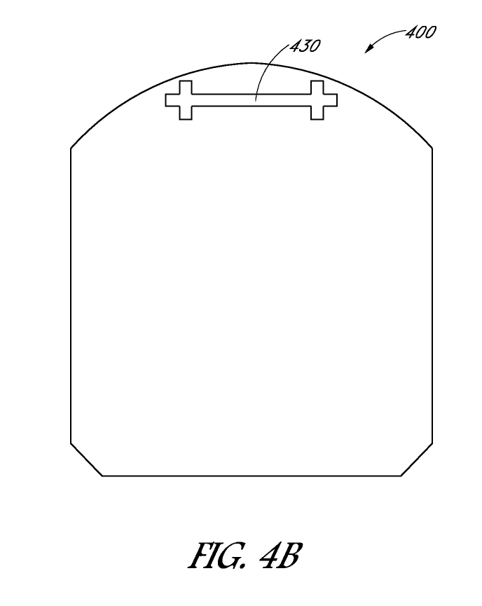

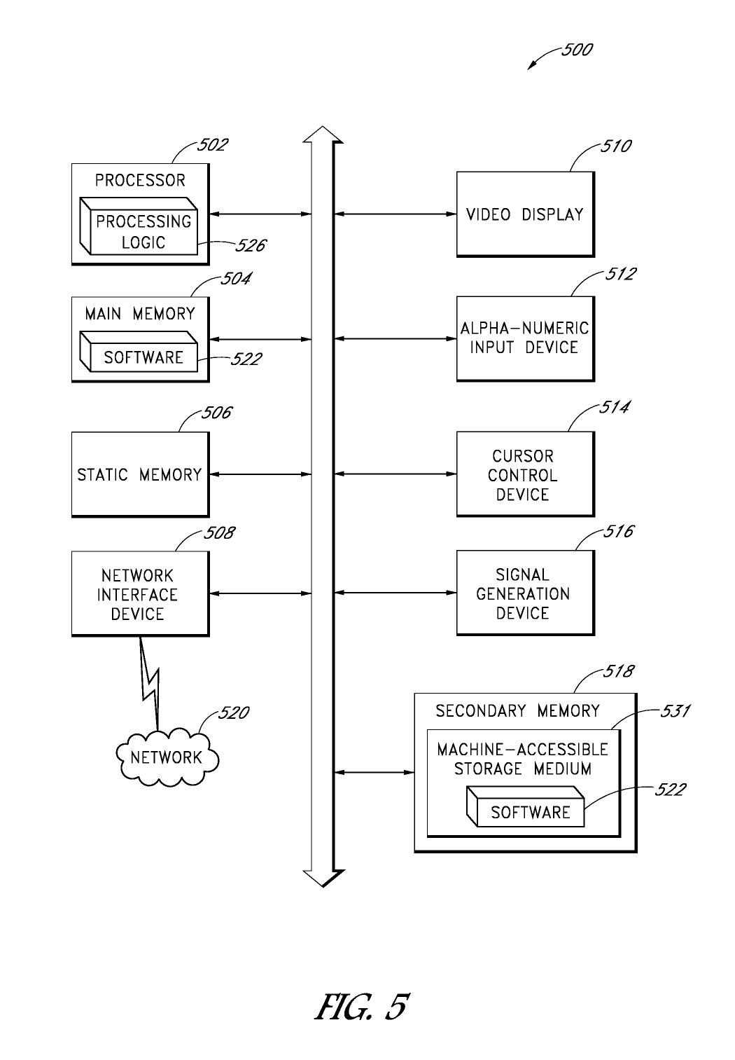

In a second example, the first major surface 208A is different from only two of the remaining three major surfaces (208B, 208C, and 208D). Particularly, FIG. 4A illustrates an end view of a multi-crystalline silicon ingot, in accordance with an embodiment of the present invention. Referring to FIG. 4A, an end 204 of a multi-crystalline silicon ingot 208 is formed from the terminating ends of a first major surface 208A and three remaining major surfaces 208B, 208C and 208D. The two major surfaces 208A and 208C both have a substantially flat portion having a surface area (when considered as an ingot projecting into the page). The remaining two major surfaces 208B and 208D both have a substantially flat portion having a surface area greater than the surface area of the surfaces 208A and 208C. Thus, from an end view, the ingot 208 is rectangular in shape. By contrast, a multi-crystalline ingot used for beam-based slicing would first be slabbed to have all four surfaces substantially the same, e.g., where surfaces 208A and 208C would otherwise be the same as surfaces 208B and 208D, as depicted by the dashed line 400. However, in accordance with an embodiment of the present invention, the ingot 208 is slabbed to have four major surfaces forming a rectangular cross-section, where the first major surface 208A is a short side of the rectangular cross-section. A portion 220 is thus retained as part of the ingot 208. In one embodiment, portion 220 is used as a sacrificial portion of the ingot 208 for beamless slicing of the ingot 208.

In an embodiment, the gripping of the portion of the ingot from operation 102 includes gripping at both ends of the ingot, into keyholes formed at each of the both ends of the ingot. For example, both FIGS. 3 and 4A illustrate an embodiment where an end 204 of the ingot 208 has keyholes 230 formed in a portion thereof. In one such embodiment, such keyholes are provided at both ends 204/206 of the ingot. In an embodiment, the keyholes 230 are formed proximate to the first major surface 204A, as depicted in both FIGS. 3 and 4A.

It is to be understood that any shape or grouping of shapes suitable for gripping by a gripper of a cutting apparatus may be formed as keyholes in the ends of an ingot. A specific, but non-limiting, embodiment includes a row of three hexagonal keyholes 230 formed at each end of the ingot, as depicted in FIGS. 3 and 4A. A variety of shapes and arrangement may be equally suitable, another example of which is depicted in FIG. 4B. Referring to FIG. 4B, a row of cross-shaped keyholes 430 is included at the end of an ingot 400. Forming the keyholes may be performed by machining the ingot or chemically etching the ingot, depending on the size and scaling needed for compatibility with a particular gripper. In an alternative embodiment, the gripper is glued with epoxy directly to the ingot without using keyholes. In such embodiments, a beamless approach is performed and wafers may be severed from the ingot in a sawing chamber. In other embodiments, holes are drilled or grooves are machined directly into the ingot.

Referring to operation 104 of flowchart 100, the method of cutting the ingot also includes partially cutting the ingot to form a plurality of wafer portions projecting from an uncut portion of the ingot. For example, referring to corresponding FIG. 2B, wires 250, e.g., from a wire saw, are used to cut wafer shapes 252 into ingot 208, as viewed at the side 208B. With respect to operation 104, the cutting is performed along the direction of the arrow labeled 1 in FIG. 2B.

In an embodiment, the extent of cutting is suitable to ultimately provide symmetrical wafers cut from ingot 208. For example, referring to FIG. 3, a mono-crystalline silicon ingot 208 is partially cut approximately to dashed line 300. In another example, referring to FIG. 4A, a multi-crystalline silicon ingot 208 is partially cut approximately to dashed line 400.

Referring to operation 106 of flowchart 100, the method of cutting the ingot also includes further cutting the ingot in a direction orthogonal to the direction of cutting in operation 104. With respect to operation 106, the cutting is performed along the direction of the arrow labeled 2 in FIG. 2B. Such cutting in the orthogonal direction is used to separate the plurality of wafer portions from the uncut portion, providing a plurality of discrete wafers. For example, referring to corresponding FIG. 2C, discrete wafers 260 are cut from ingot 208, and discrete from uncut portion 220 of ingot 208.

In an embodiment, the further cutting of the ingot includes forming the plurality of discrete wafers 260 to each have four major edges of approximately the same length. For example, referring to FIG. 3, a mono-crystalline silicon wafer cut from ingot 208 will have four major edges 208B, 208C, 208D and along dashed line 300 all of approximately the same length and geometry. In one embodiment, the four major edges approximately form a square, as would be the case depicted in FIG. 4A, if the ingot 208 was cut along dashed line 400.

In an embodiment, then, the partially cutting of operation 102 and the further cutting of operation 104 are performed approximately orthogonal to one another, e.g., first into surface 208C and then across ingot 208, parallel to surface 208C. In one embodiment, the gripper 202 is moved relative to the wires 250. In an alternative embodiment, however, the wires 250 are moved relative to the gripper 202.

In an embodiment, further cutting the ingot 208 to separate the plurality of wafer portions 252 from the uncut portion 220 includes separating the plurality of discrete wafers 260 from the portion 220 of the ingot 208 which includes the keyholes 230. In one such embodiment, the portion 220 of the ingot 208 with the keyholes has a thickness (T) of approximately, or greater than, 10 mm parallel with the direction of the plurality of wafer portions 252.

In an embodiment, the operation 106 of further cutting the ingot 208 includes supporting the plurality of wafer portions 252 with a wafer-receiving catcher 270 to provide the plurality of discrete wafers 260 directly into the wafer catcher 270, as depicted in FIG. 2C. In an embodiment, the method of cutting the ingot 208 further includes reusing the uncut portion 220 of the ingot 208 to subsequently form another ingot.

In an embodiment, both partially cutting (operation 104) and further cutting (operation 106) the ingot 208 includes using a same wire cutting technique such as, but not limited to, diamond wire cutting and slurry slicing. Diamond wire (DW) cutting is the process of using wire of various diameters and lengths, impregnated with fine diamond particles of various pre-selected sizes and shapes to cut through materials. Slurry saws for slurry slicing typically use bare wire and include the cutting material (e.g., silicon carbide, SiC) in the cutting fluid (e.g., polyethylene glycol, PEG). By contrast, DW cutting typically does not use loose abrasives but rather only coolant fluid (either water-based or glycol-based) to lubricate, cool the cut, and remove debris.

In accordance with an embodiment of the present invention, a wire saw may refer to a machine using a metal wire or cable for cutting. There are typically two types of wire saw movements, namely continuous (or endless or loop) and oscillating (or reciprocating). The wire may have one strand or many strands braided together. The wire saw uses abrasives to cut. Depending on the application, diamond material may or may not be used as an abrasive, as described above. A single-strand saw may be roughened to be abrasive, abrasive compounds can be bonded to the cable, or diamond-impregnated beads (and spacers) can be threaded on the cable.

Thus, in an exemplary embodiment, in the case of a mono-crystalline silicon ingot, an initially round ingot undergoes a slabbing and polishing process to form a pseudo-square ingot. The removal of wing material in the slabbing process typically involves removal of material with a center thickness approximately in the range of 15-20 mm. However, only three sides of silicon wing material is removed, leaving the fourth side intact and only slightly polished to maintain parallelism with the opposite side. At both ends of the ingot, at the fourth wing area, a suitable holding key pattern is machined to be matched with the working piece of the wire saw. Or, the working piece of the wire saw may be revised to match the pattern on the ingot silicon wing area. Either approach provides an opportunity to directly hold the ingot during slicing of the ingot during a wire saw slicing process. At the end of the ingot slicing, the wire web movement is temporarily halted and re-tensioned to a flat surface, a wafer catcher is inserted into the wireweb to hold the three sides of the sliced wafer (e.g., the fourth side of each wafer is still attached to the top wing). It is noted that wire web bow may be a concern at this stage, so retracting of the workpiece and re-tensioning of the flat web may be performed. The wire web movement is then reinitiated and a slight movement of the work piece/ingot relative to the wireweb is made along the ingot long axis perpendicular to the web wire movement direction. Such a movement may need only be approximately, or less than, one pitch of a web main roller groove (e.g., approximately 300 microns). This secondary cut is used to detach, and make discrete, all of the wafers from the remaining silicon wing. The discrete wafers may then be retrieved from the wire saw via the wafer catcher and moved to a pre-cleaner. Or, the discrete wafers may be pre-cleaned at the wire saw with coolant or an extra loop of cleaning agent (e.g., more likely to be realized for the DW cutting process where no slurry is used), either before or after the final slicing/severing operation. The remainder of the silicon wing may then be cleaned and recycled in an ingot puller.

In another exemplary embodiment, in the case of a multi-crystalline silicon ingot, an extra amount of silicon is retained in a casted ingot squaring step, e.g., approximately 10 mm is retained at one side to provide a rectangular ingot. This additional material may be used to form keyholes therein and, thus, be used for a beamless slicing approach similar to the approach described above. At the end of the process, the remained multi-crystalline silicon may be recycled in a multi-cast furnace. In both the mono-crystalline and multi-crystalline silicon ingot cases, epoxy bonding and debonding operations are no longer needed for slicing the ingots steps.

In an embodiment, a solar cell is fabricated from one of the wafers generated by the above beamless slicing approach. For example, a photovoltaic cell may be formed using a mono-crystalline silicon wafer fabricated by a beamless slicing methodology. Photovoltaic cells, commonly known as solar cells, are well known devices for direct conversion of solar radiation into electrical energy. Generally, solar cells are fabricated on a semiconductor wafer or substrate using semiconductor processing techniques to form a p-n junction near a surface of the substrate. Solar radiation impinging on the surface of, and entering into, the substrate creates electron and hole pairs in the bulk of the substrate. The electron and hole pairs migrate to p-doped and n-doped regions in the substrate, thereby generating a voltage differential between the doped regions. The doped regions are connected to conductive regions on the solar cell to direct an electrical current from the cell to an external circuit coupled thereto. It is to be understood, however, that the above beamless ingot slicing approaches are not limited to generating wafers for solar cell fabrication.

Aspects also include fabrication or machining of a suitable gripper for direct (beamless) slicing of an ingot. For example, referring again to FIG. 2A, a gripper 202 for holding an ingot 208 during a cutting process includes a first end 202A and a second end 202B. In one embodiment, each of the ends 202A and 202B has a plurality of keys for gripping a respective set of keyholes of the ingot directly. The gripper 202 also includes a central portion 202C between and aligning the first and second ends 202A and 202B, and adaptable to integrate with a cutting apparatus. In one embodiment, each end 202A and 202B includes a row of three hexagonal keys, e.g., suitable for gripping the keyholes 230 of FIGS. 3 and 4A. In one embodiment, each end 202A and 202B includes a row of cross-shaped keys, e.g., suitable for gripping the keyholes 430 of FIG. 4B. In one embodiment, the central portion 202C is further adaptable to move the ingot 208 relative to a wire cutter in first and second cutting directions, the first and second cutting directions orthogonal to one another. In an embodiment, the gripper 202 is suitably sized to hold the ingot very steadily, tolerating no more than a few microns of movement.

In an aspect of the present invention, embodiments of the inventions are provided as a computer program product, or software product, that includes a machine-readable medium having stored thereon instructions, which is used to program a computer system (or other electronic devices) to perform a process or method according to embodiments of the present invention. A machine-readable medium may include any mechanism for storing or transmitting information in a form readable by a machine (e.g., a computer). For example, in an embodiment, a machine-readable (e.g., computer-readable) medium includes a machine (e.g., a computer) readable storage medium (e.g., read only memory (“ROM”), random access memory (“RAM”), magnetic disk storage media or optical storage media, flash memory devices, etc.).

FIG. 5 illustrates a diagrammatic representation of a machine in the form of a computer system 500 within which a set of instructions, for causing the machine to perform any one or more of the methodologies discussed herein, is executed. For example, in accordance with an embodiment of the present invention, FIG. 5 illustrates a block diagram of an example of a computer system configured for performing a method of cutting an ingot for solar cell fabrication. In alternative embodiments, the machine is connected (e.g., networked) to other machines in a Local Area Network (LAN), an intranet, an extranet, or the Internet. In an embodiment, the machine operates in the capacity of a server or a client machine in a client-server network environment, or as a peer machine in a peer-to-peer (or distributed) network environment. In an embodiment, the machine is a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers or processors) that individually or jointly execute a set (or multiple sets) of instructions to perform any one or more of the methodologies discussed herein. In one embodiment, the machine-computer system 500 is included with or associated with a wire cutting apparatus, which may include a gripper, for cutting an ingot.

The example of a computer system 500 includes a processor 502, a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a secondary memory 518 (e.g., a data storage device), which communicate with each other via a bus 530. In an embodiment, a data processing system is used.

Processor 502 represents one or more general-purpose processing devices such as a microprocessor, central processing unit, or the like. More particularly, in an embodiment, the processor 502 is a complex instruction set computing (CISC) microprocessor, reduced instruction set computing (RISC) microprocessor, very long instruction word (VLIW) microprocessor, processor implementing other instruction sets, or processors implementing a combination of instruction sets. In one embodiment, processor 502 is one or more special-purpose processing devices such as an application specific integrated circuit (ASIC), a field programmable gate array (FPGA), a digital signal processor (DSP), network processor, or the like. Processor 502 executes the processing logic 526 for performing the operations discussed herein.

In an embodiment, the computer system 500 further includes a network interface device 508. In one embodiment, the computer system 500 also includes a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 516 (e.g., a speaker).

In an embodiment, the secondary memory 518 includes a machine-accessible storage medium (or more specifically a computer-readable storage medium) 531 on which is stored one or more sets of instructions (e.g., software 522) embodying any one or more of the methodologies or functions described herein, such as a method for managing variability of output from a photovoltaic system. In an embodiment, the software 522 resides, completely or at least partially, within the main memory 504 or within the processor 502 during execution thereof by the computer system 500, the main memory 504 and the processor 502 also constituting machine-readable storage media. In one embodiment, the software 522 is further transmitted or received over a network 520 via the network interface device 508.

While the machine-accessible storage medium 531 is shown in an embodiment to be a single medium, the term “machine-readable storage medium” should be taken to include a single medium or multiple media (e.g., a centralized or distributed database, or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of embodiments of the present invention. The term “machine-readable storage medium” shall accordingly be taken to include, but not be limited to, solid-state memories, and optical and magnetic media.

Thus, methods of cutting ingots for solar cell fabrication, as well ingots and grippers there for, have been disclosed. In accordance with an embodiment of the present invention, a method of cutting an ingot includes gripping a portion of the ingot directly with a gripper of a cutting apparatus. The ingot is partially cut to form a plurality of wafer portions projecting from an uncut portion of the ingot. The ingot is further cut to separate the plurality of wafer portions from the uncut portion, to provide a plurality of discrete wafers. In one such embodiment, gripping the portion of the ingot includes gripping at both ends of the ingot, into keyholes formed at each of the both ends of the ingot.

1. A method of cutting an ingot, the method comprising:
gripping a portion of the ingot directly with a gripper of a cutting apparatus;
partially cutting the ingot to form a plurality of wafer portions projecting from an uncut portion of the ingot;
further cutting the ingot to separate the plurality of wafer portions from the uncut portion, providing a plurality of discrete wafers.

2. The method of claim 1, wherein gripping the portion of the ingot comprises gripping at both ends of the ingot along a first of four major surfaces oriented along a central axis of the ingot, the first major surface different from two or more of the remaining three major surfaces.

3. The method of claim 2, wherein the ingot comprises mono-crystalline silicon, the remaining three major surfaces each comprise a substantially flat portion having a surface area, and the first major surface comprises a substantially flat portion having a surface area less than each of the surfaces areas of the substantially flat portions of the remaining three major surfaces.

4. The method of claim 3, wherein further cutting the ingot comprises forming the plurality of discrete wafers to each comprise four major edges of approximately the same length.

5. The method of claim 2, wherein the ingot comprises multi-crystalline silicon, the four major surfaces forming a rectangular cross-section, and wherein the first major surface is a short side of the rectangular cross-section.

6. The method of claim 5, wherein further cutting the ingot comprises forming the plurality of discrete wafers to each comprise four major edges that approximately form a square.

7. The method of claim 1, wherein gripping the portion of the ingot comprises gripping at both ends of the ingot, into keyholes formed at each of the both ends of the ingot.

8. The method of claim 7, wherein further cutting the ingot to separate the plurality of wafer portions from the uncut portion comprises separating the plurality of discrete wafers from a portion of the ingot comprising the keyholes.

9. The method of claim 8, wherein the portion of the ingot comprising the keyholes has a thickness of approximately, or greater than 10 mm parallel with the direction of the plurality of wafer portions.

10. The method of claim 1, wherein both partially cutting and further cutting the ingot comprises using a same wire cutting technique selected from the group consisting of diamond wire cutting and slurry slicing.

11. The method of claim 10, wherein the partially cutting the ingot and the further cutting the ingot are performed approximately orthogonal to one another, based on movement of the gripper relative to the wire cutting technique.

12. The method of claim 11, wherein the further cutting is performed based on an approximately 1 pitch movement of the gripper relative to the wire cutting technique along a long axis of the ingot.

13. The method of claim 1, wherein further cutting the ingot comprises supporting the plurality of wafer portions with a wafer-receiving catcher to provide the plurality of discrete wafers directly into the wafer catcher.

14. The method of claim 1, further comprising:
reusing the uncut portion of the ingot to form a second ingot.

15. A solar cell fabricated according to the method of claim 1.

16. An ingot for fabricating a plurality of solar cells, the ingot comprising:
four major surfaces oriented along a central axis of the ingot, the first major surface different from two or more of the remaining three major surfaces; and
a pair of ends approximately orthogonal to the four major surfaces.

17. The ingot of claim 16, wherein the ingot comprises mono-crystalline silicon, the remaining three major surfaces each comprise a substantially flat portion having a surface area, and the first major surface comprises a substantially flat portion having a surface area less than each of the surfaces areas of the substantially flat portions of the remaining three major surfaces.

18. The ingot of claim 16, wherein the ingot comprises multi-crystalline silicon, the four major surfaces forming a rectangular cross-section, and wherein the first major surface is a short side of the rectangular cross-section.

19. The ingot of claim 16, further comprising:
keyholes formed at each of the both ends of the ingot.

20. The ingot of claim 19, wherein the keyholes are formed proximate to the first major surface.

21.-24. (canceled)
